(19) United States
(12) Patent Application Publication
(10) Pub. No.: US 2014/0225468 A1
(43) Pub. Date: Aug. 14, 2014

(54) Remote integrated magnetic/elctro-magnetic AC/DC energy device/apparatus

(71) Applicant: Sonny Loyd Chambers, Brooklyn, NY (US)

(72) Inventor: Sonny Loyd Chambers, Brooklyn, NY (US)

(21) Appl. No.: 13/815,221

(22) Filed: Feb. 11, 2013

(51) Int. Cl. H02K 1/06

(52) U.S. Cl. CPC H02K 1/06; Y10S 74/09; H02K 53/00
USPC 310/152; 74/DIG. 9

(57) ABSTRACT

A remote power source/power-supply device and remote integrated electromagnetic/magnetic rotor or armature (17) and shaft (14) device or means (38) including mechanical means (motor) (36) and a cycle loop of transformer network (31) and a digital (24) distributor unit (25) is provided. The electro-magnetic-rotor or armature and fixed member (shaft) device or means and the mechanical means comprise at least two attractive adjacent magnetic or/and electromagnetic opposite (N; S) sign-poles (33) and two attractive adjacent same sign-poles (N; N) that are thereby able to focus-channel power; and also put out the effort to efficiently contract and repel the magnetic rotor or armature or magnetic mechanical means, for driving the motor or rotor or armature and (shaft) to potential; speeds as fast as an electronic pulse. The integrated system (37) further comprise a remote (SLF) or (ELF) channel (15) transceiver unit (16) for remotely communicating the power signals (20) through the power spectrum. Further, a remote wireless electronic socket.(19) is also provided by coupling the system's remote (SLF) (ELF) transceiver channel to it.

### CROSS REFERENCE TO RELATED APPLICATION

This application claims the benefit of provisional patent application No. 61/849,222 filed on Jan. 23, 2013 by the present inventor.

### SEQUENCE LISTING OR PROGRAM

not applicable

### TECHNICAL FIELD

### Background Field of Invention

This invention relates to quality power source/power supply/source of power device, powerful AC/DC alternating generating or rotating and fixed member (shaft), mechanical devices or apparatus, motor or mechanical means and socket device, especially power source device/;source of power.

### BACKGROUND ART

### Background of Invention

### Prior Art

Commercial and residential areas are supplied with power by power source/supply that use wire, cables and un-remote conductors to supply power. But these wires and cables that are not remote, are dangerous and can cause power outages, and they can also cause people there lives when there is bad weather. Bad weather can cause the traditional landline power supply system to shut down.

### Technical Problem

Inventors create many power supply inventions. The related invention provide a design which illustrates an external power supply, supplying power to a unit using conductor as in U.S. Pat. No. 8,332,671 by Nagao. This concept is useless because power line conductors such as wire and cables are still employed to make the connections, and the system is thereby vulnerable to bad weather, and weather damages are expensive.

Thus if there is bad weather, there will be a power outage.

Because of the fuel they use, automobile produce dangerous emission. An automobile motor emits gasses that are harmful to the ozone-layer, and because of that, the ozone layer is depleting.

Thereafter an inventor came up with an idea. The idea includes an hybrid motor. An example of the relative matter is in U.S. Pat. No. 8,335,604. In this patent application an engine control module activate a heater for an oxygen sensor of an exhaust system. The heater is able to vary the air mixture according to the sensor of the exhaust system, to improve emission. But the improvement is incremental.

Because of the emission quality that the context of this prior art fail to provide, this prior article is useless. Consequently, today because of a hole in the ozone layer, bad weather intensifies, and the environment is being destroyed and thereby residential and commercial areas and capital.

Although hybrid motors are advanced emission motors, they still emit dangerous emission.

The rotating and fixed members (shaft) of a mechanical device such as an alternator or generator is used to induce voltage to the unit. But these rotors or armature devises are not design to rotate in perpetual motion. That is why the rest of the generator or alternator unit is employed to keep the rotor or armature rotating. A fuel system or a secondary energy system is used to keep the power going. A relative matter on the subject is in U.S. Pat. No. 8,339,006 by Hall. The prior art provides context of a rotor or armature comprising a generator. The rotor or armature has the ability to generate responding attractive magnetic field that induce voltage with the winding. However the armature or rotor still need a second form of energy to rotate in perpetual-motion, and thereby is expensive to run because they are only a part of a huge dependable unit. Further, because of their size, these large units are expensive to manufacture and maintain because there are more parts that are apparatuses that are expensive.

Commercial and residential areas are equipped with electronic sockets to plug components or equipment. These sockets are design to couple components that have wires. But wires can short-out and cause fire. And wires that are coupled to such a socket are limited and confined to a small area. The components that are coupled cannot be portable. A related prior art is provided in U.S. Pat. No. 8,206,019 by Chen Jung. This prior art article recites a connector assembly comprising a protection member for disposing a light onto it. Several housing are also provided for shielding a coupled component

A protection system is a good thing, but this prior art recites a socket for coupling wired component. And the protection of wire shortage would not be needed if the sockets were more remote.

Relating to the prior art that recite an external power source, such invented product is expensive to manufacture, and is dangerous because the wire conductors that are employed are hanged from the streets if the product was used for coupling with a power line.
a) To receive power the wire conductors must be in good condition and not broken. When there are broken wire conductors, power supply and post, it may cause trillions of dollars to fix.
b) When a power line's wire conductor brakes, it is dangerous for those who are in the area.
c) The wire conductor of the power supply unit may have a short.

Technical Solution

### Background of Invention Objects And Advantages

Accordingly, besides the object and advantages of the remote power source/supply magnetic rotor or armature and fixed member (shaft), electro-magnetic means (motor) and the remote socket described in my above patent, several object and advantages of the present invention are:

a) To provide quality.

b) to provide great ultra-capital coordinates and gain

c) to provide a power source/supply that is remote.

d) to provide repairs that are inexpensive.

e) to provide inexpensive manufacturing.

f) to provide a integrated magnetic energetic rotating and fixed (shaft) device or apparatus that is independent means that can be incorporated integrally.

g) to provide a magnetic energetic rotary device that is able to rotate in perpetual motion.

h) to provide an electronic energy producing magnetic rotor or armature and fixed member (shaft) device that is remote or wire-less.

i) to integrate an independent generating device or apparatus into a micro-chip

j) to provide a lighter device such as a cell-phone or lab top when the present invention is employed and integrated.

k) to provide electro-magnetic means or a motor that completely or/and partially eliminate dangerous emission and put back (compensate) the depleting magnetic field of the earth.

l) to provide a motor with more power.

m) to provide a motor with more great speed.

n) to provide a motor with speeds as fast as an electronic pulse

o) to provide a luxurious: quite, smooth comfortable ride or drive.

p) to provide a wireless socket.

q) to make commercial and residential electronic components more portable.

r) to eliminate commercial and residential fire.

s) to compensate for capital, for the shortage of energy source such as oil.

Further object and advantages are to provide a better power-source/power-supply system, which may incorporate electro-magnetic means (motor) for cleaner emission, which may incorporate an independent integrated magnetic-armature or rotor/fixed member (shaft) device/apparatus, which is able to generate and remotely communicate power signals to the wireless socket. Further objects and advantages will become apparent from the consideration of the ensuing description and drawings.

### Mode of Invention

### SUMMARY

In accordance with the present invention, an electro-magnetic power source, including, (armature or rotor) magnetic-mechanical means is incorporated with two remote power spectrum channels, one is an electromagnetic (SLF or ELF) focus-channel of magnetic-mechanical means (motor), that communicate to adjacent sign poles (N; N), and the other channel include at least one (SLF) or (ELF) filter circuit. And the remote communication channel is able to convey power signals that are able to connect to the motor or electro-magnetic means, and the motor or electro-magnetic means is including a transceiver or receiver unit that is connected to the low-band remote filter circuit and the filter's power channel is able to filter the power signals to and from the independent magnetic generating armature or rotor fixed member (shaft) device or apparatus which employs the filter circuit and thereby is able to communicate through the (ELF) power spectrum channel and to a wireless or remote electronic socket employing a transceiver or receiver unit. Further, the electro-magnetic mechanical means (motor) are able to remotely communicate magnetic fields that drive the motor. And the integrated independent magnetic-rotor or armature and fix member (shaft) device is able to indigenously induce current and voltage and electricity all by it's self (independently).

### DRAWING

### Figures

In the drawings, closely related figures have the same numbers but deferent alphabetical suffixes.

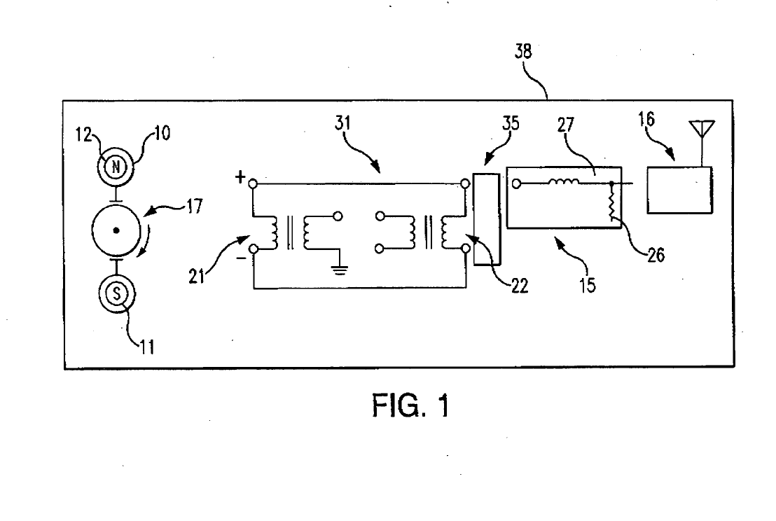

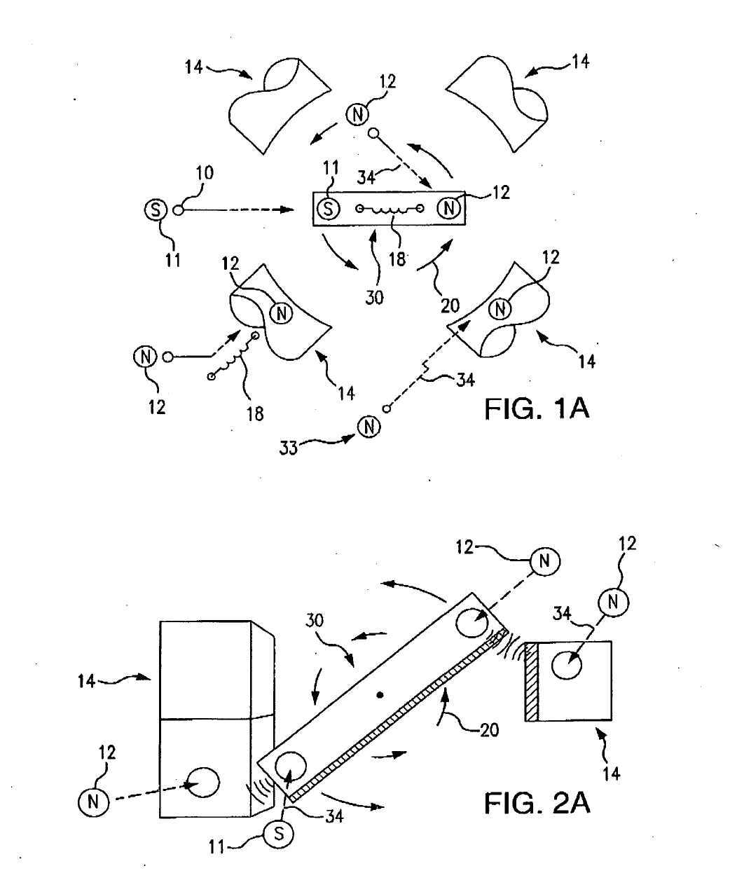

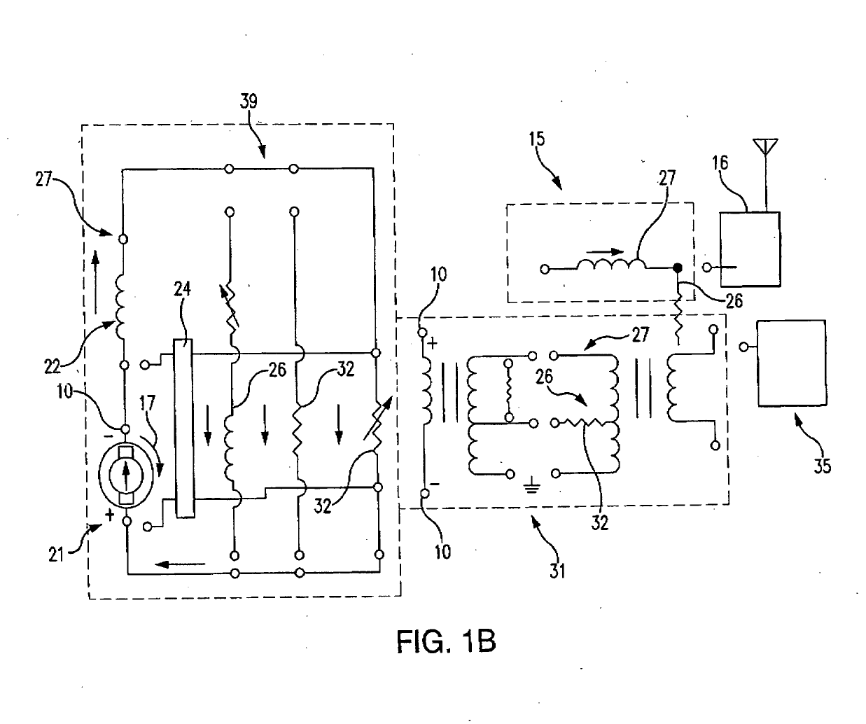

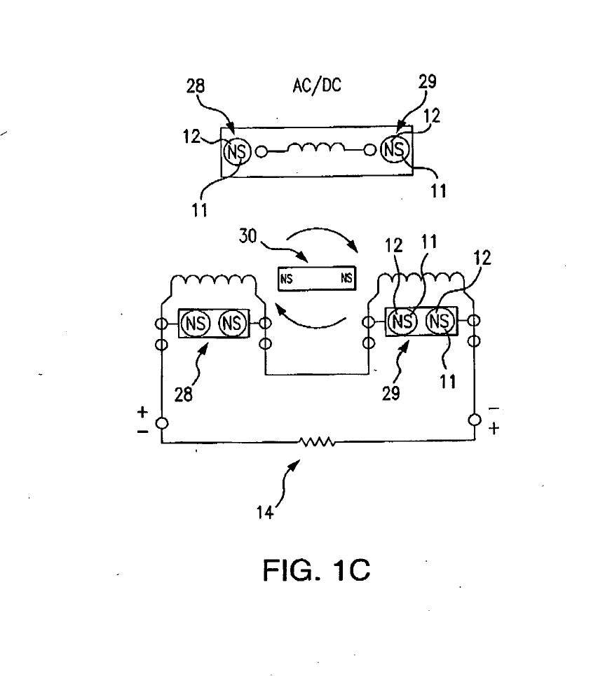

FIG. 1 shows a schematic diagram of connections of a magnetic armature and rotor fix member (shaft) device, transformer network, a filter circuit and a transceiver-unit.

FIG. 1A shows a schematic illustration of an magnetic/electro-magnetic AC/DC arrangement to a generating rotor armature and shaft device.

FIG. 1B shows a schematic and box diagram of connection of the winding circuits of an independent magnetic/electro-magnetic integrated rotor or armature generating device or apparatus and connections of a looped transformer network and the connections of a low band-pass (ELF) or (SLF) filter circuit channel and a transceiver unit.

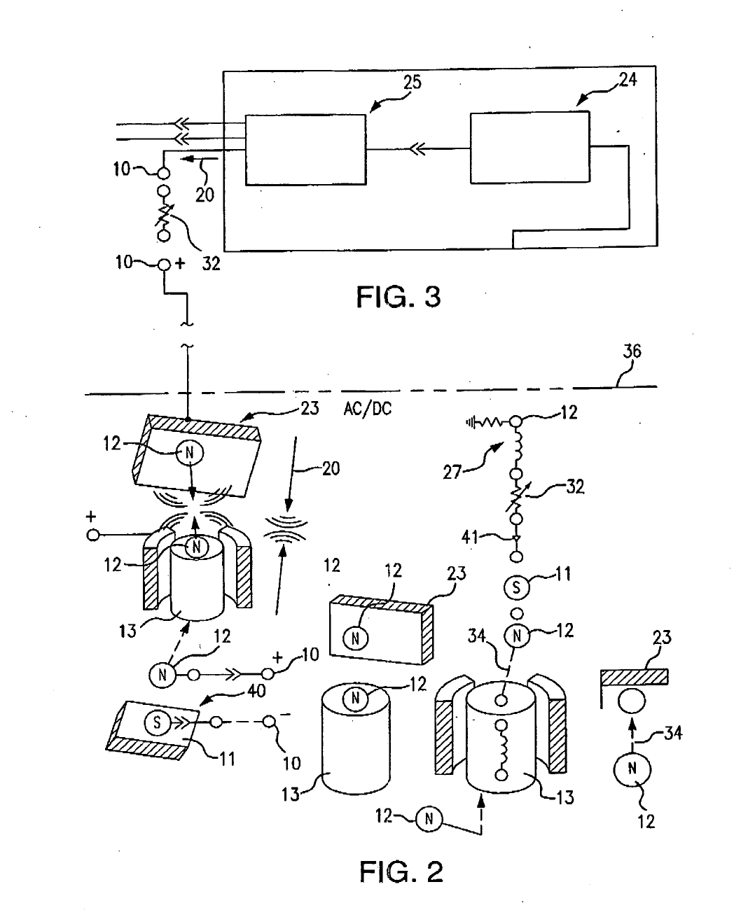

FIG. 2 shows lamination and connections of electro-magnetic poles on a cylinder cover (cylinder-head) for inducing magnetic force to the electro-magnetic mechanical means (motor).

FIG. 2A shows lamination of sing-poles connections of an independent indigenous magnetic-rotor or armature and fixed member (shaft) device or apparatus.

FIG. 3 shows a schematic and box diagram of connections of a digital distributer unit, which include a clock and a variable resistor.

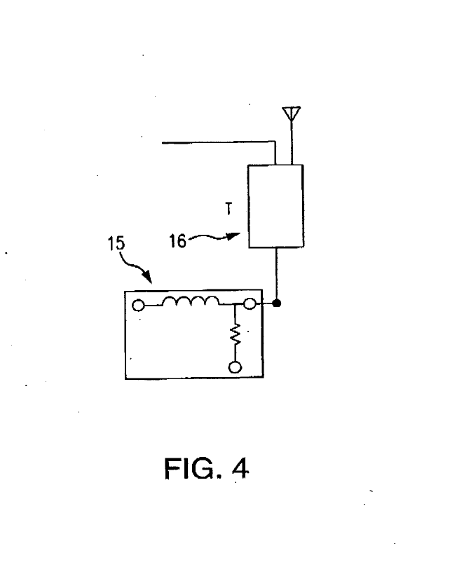

FIG. 4 shows connections of a remote electronic socket and a (ELF) filter circuit.

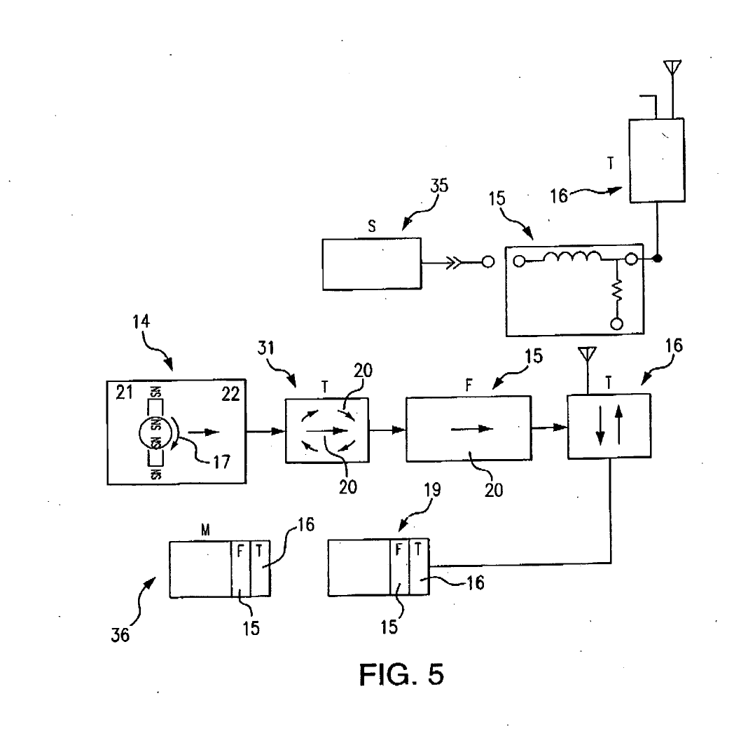

FIG. 5 shows a box and schematic diagram that illustrates signal flow and remote connections of the above embodiments incorporating a remote power system and making remote connections.

### REFERENCE NUMBERS

10 terminal

11 south magnetic pole

12 north magnetic pole

13 piston

14 cylinder or (fixed member shaft)

15 low band-pass (ELF) or (SLF) filter circuit

16 transceiver unit

17 magnetic rotor or armature

18 winding (coil)

19 electronic socket

20 signal flow

21 input section

22 output section

23 cylinder cover or (cylinder head)

24 clock circuit

25 distributor circuit

26 shunt parallel circuit

27 series circuit

28 plurality of magnetic pole unit number 1

29 plurality of magnetic poles unit number 2

30 rotor or armature blade

31 transformer network

32 resistor

33 magnetic pole

34 lamination

35 power source/supply device

36 mechanical means (motor)

37 integrated system

38 a remote magnetic/electro-magnetic rotor/armature and shaft generating alternating power (SLF) or (ELF) channel communication device or apparatus

39 winding circuit

40 bottom side of mechanical mean's or (motors) cylinder

### SPECIFICATION

### Detail Description

The connections of a powerful integrated magnetic rotor or armature and fixed members (shaft) device is provided in the illustration FIG. 1A. A wire winding (coil) 18 is connected to the magnet of the rotor. The magnetic rotor or armature 17 and fixed member (shaft) 14 device or apparatus is provided, by providing a ring such as a cylinder (shaft) that is connected to a same opposing electro-magnetic-pole terminals, in which are the same sign poles from the poles of the terminal of the first propeller(blade) 30 section for repelling the propeller in forward motion 20. The propeller is connected by bolt screw or the dynamic coordinates of evaluated velocity of magnetic force, which is predetermine. The second blade section is connected to deferent sign-pole terminals and is attracted and responsive to magnetic force herein. The poles of the cylinder ring are attractive and responsive signs from the poles of the propeller blade. For example, the first electro-magnet blade section (terminal) is connected to the north pole (N) 12, and at least one section of the cylinder (fixed member shaft) 14 is connected to a north pole terminal (N) 12 which is the same sign-pole of the first blade section. The second blade section is connected to a south pole (S) 11, which, as a result, is attractive and responsive to the north pole of another cylinder section (fixed member shaft). The magnetic-rotor or armature and fixed member (shaft) could be electro-magnetic or just magnetic. It provide a source of power and induce current, magnetic field, voltage and thereby electronic energy.

Further, mechanical means may be provided to form electro-magnetic or/and magnetic means for influencing power.

At least two transformers are coupled and loop in a cycle and connected in series with two electromagnetic rotors or armature and fixed member device having one transformer cycle a lower stage transformation and the higher stage rotor or armature with transformer cycle and output higher stage voltage or having both transformers cycle the same and therefore, the rotors or armature voltage basically the same. Both method step up the resulting power.

A transformer network 31 is provided and illustrated in FIG. 1B for inducing a powerful electronic infinite continuum hereof. At least two transformers are employed. Connection commence as fallow. From the positive output stage 22 of a first step-up transformer, a connection is made to the positive input primary stage 21 terminal 10 of a second transformer which is a step-down transformer. From a negative output terminal of the second stage of the first transformer, a connection is made to the input negative terminal of the primary stage of the second (step-down) transformer. At the positive input terminal of the primary stage of the step-up first transformer, a connection is made at the positive output second stage terminal of the second transformer (step-down). From the negative input stage's terminal of the first transformer (step-up), a connection is made to the negative out-put second stage terminal of the second transformer (step-down), thereby creating a continuous cycle for the continuation of multiple power in addition. From the transformer network's cycle, a connection is made respectively to the input terminals of a power source device. With a resistor 32, a series connection is then made to the center winding of the output (second stage) of the first (step-up) transformer to the input terminal of the center winding on the second (step-down) transformer. A shunt 26 load resistor is coupled in shut with the circuit. In this manner, the device will be able to induce current from the same low stage transformer connection to the center winding, and voltage, because the step-up transformer's deficiency current is compensated by the higher current from the step-down transformer. A capacitor is respectively connected in shunt with the transformer network at the output terminals, for a loud channel advancing the center frequency resonance and power relativity to the system.

For great speed and more power FIG. 3 demonstrate connections. In the illustration, a motor vehicle's distributor 25 is comprising a digital circuit. Connections commence as fallow. A clock 24 is provided. From the output 22 of the clock's terminals 10, connections are made respectively to the input 21 terminals of a distributer unit 25. The distributer is now digital and is able to output digital pulse. The pulse are respectively injected into the electro-magnetic poles of the cylinders-head of the motor. Thereby constituting a digital distributor unit. This configuration connection provide the motor or mechanical means with speed as fast as an electronic pulse. Further, at the output 22 of the clock, a connection is made respectively to a variable resistor 32 for varying the speed and voltage flowing to the cylinder-head, electro-magnetic poles of piston and the magnetic field of the cylinder.

Electro-integrated magnetic mechanical means 36 are formed arranged and provided as demonstrated in FIG. 2. Connections begin as fallow in the arrangement. Electro-magnetic means connected to the mechanical means (motor) of a motor vehicle. The motor vehicle's digital distributor unit 25 is adapted. At least two cylinders 23 and two pistons 13 are formed out of a nonmetallic material. The material is fabricated so that it would not be effected by the magnetic field. Same sign electro-magnetic poles 33 (N; N) of opposition are connected (lamination) 34 respectively to one section of the cover (cylinder head) 23 of the cylinders with reasonable force of coordinative dynamics in consideration to apply a powerful value on the effort to the attraction herein. A (ELF) or (SLF) filter circuit is able to be connected to the terminal of the north pole of the cylinder head to focus and thereby channel the powerful magnetic field. Another plurality of same sign poles are respectively laminate 34 to the top of both pistons (N; N) for providing an attractive effort and driving the piston forward in motion. For strong (DC) direct current generations and thereby more power to the motor, around the pole pieces, a serial winding circuit connection is made from the first winding terminal to the electro-magnetic (N) north pole of the cylinder head. From another side of the winding at the second terminal, another north pole connection is made to another (N) north pole at the bottom side of the piston. An interconnecting adjacent (S) south electro-magnetic pole is interconnected to the output 22 terminal 10 of a diode 41. From the input terminal of the diode, a serial interconnection is made respectively to a variable resistor.

From the output terminal of the resistor, an interconnection is made in series with the winding. And from the opposite terminal of the winding, a connection is made to the north electro-magnetic pole of the cylinder-head. When the power is on in the (N) north pole of the cylinder-head, the adjacent remote poles get attractive and repel the north pole of the piston face. During this time period the diode will be in the on position thereby stopping the current from flowing to the south pole and allowing both remote adjacent (N) north electro-magnetic poles to repel. When current stop flowing from the variable resistor and the diode's circuit opens, the diode stop directing and the south (S) electro-magnetic pole activates, attracts and generates voltage and current. Or the alternative where, for example, a 0 (−) bit represent 11 volt and 1 bit (+) represent 12 volt. When the voltage of the variable resistor is at 11, the diode circuit opens and let current conduct. When the voltage is at 12v, the variable resistor conduct voltage to close the diode's circuit and stop the conductivity from the electro-magnetic field of the north pole to the adjacent interconnecting south pole that is adjacent to the north pole of the cylinder-head.

In the alternative, for (AC) alternative current and thereby ultra-power to the motor, at least two attractive sign-poles 33 are connected at the bottom of the pistons 13. Another plurality of attractive contracting sign poles (S; N) are respectively laminated 34 at the bottom of the piston 13 and at the bottom side of the cylinder shaft 40, both poles facing each other, for attraction and contraction. The electro-magnetic poles that is laminated 34 to the cylinder head and the top of the piston, are connected to a positive terminal 10. The electro-magnet poles that are laminated to the bottom of the piston and the bottom of the cylinder shaft are connected respectively to (N) positive (+) and (S) negative (−) terminal. A shunt Generating integrated circuit is connected in parallel with the motor for strength in the pole pieces, voltage and power that thereby induce a ultra-powerful magnetic field and force. With the (ELF) or (SLF) filter circuit connected to the output of the sing poles, the filter circuit is able to channel the band of magnetic field to efficiently drive the motor with increased power thereby the motor emitting powerful efficient magnetic field that is able to help put back (compensate) the depleted magnetic field of the earth to protect the ozone-layer. This arrangement form an ultra-powerful electromagnetic/mechanical means (AC/DC) power device 36, because of the plurality of the shunt duplex arrangement and the direction of the simplex arrangement.

Both pistons are respectively placed into the cylinder. The cylinders are then closed. The crank shaft is then connected to the piston and connecting rod. And that thereby forming a powerful electromagnetic mechanic means (motor) device.

An alternative method may employ a fuel system with the magnetic means (motor) If so connections are initialize as fallow. illustrated in FIGS. 2 and 3. From a distributer 25 of a motor, a connection is made respectively to the electro-magnet of the magnetic-mechanical means or motor. From the terminals of a fuel injector, a connection is made to the motor. Thereby fuel is able to be injected into the motor simultaneously with the powerful magnetic field of the magnetic-mechanical means (motor). Thereby influencing more power and less fuel, providing that the cylinders and pistons of the motor are composed out of material that will not interfere with the magnetic field of the electro-magnetic means (motor).

Illustration FIGS. 1A and 1C show arrangements connections and laminations of an independent integrated magnetic rotor or armature and shaft device or apparatus. The independent integrated magnetic rotor or armature 17 and fixed member (shaft) 14 device or apparatus may be used to form an electro-magnetic or just magnetic device. In this method, the magnet that is employed is non-electro. The independent integrated magnetic rotor device or apparatus herein may employ at least one electro-magnetic pole 33 for activating the natural magnetic rotor. Or if the magnetic rotor armature and fixed member (shaft) are pure magnet, it will be able to be activated manually or electronically. Configuration commence as fallow. A rotor armature and fixed members (shaft) is provided. In the fixed member (shaft) or cylinder of the rotor, pure magnetic poles 33 or laminated to the blades 30 of the propeller. The pure natural magnet's rotor blade is laminated 34 to a same sign attractive opposing responsive magnetic-pole, which is the north pole (N; N). The same lamination is made respectively to the cylinder (fixed member shaft) 14 of the pure natural magnetic rotor. A plurality of attractive magnetic or/electro-magnetic sign-poles (N; N) and (N S) are respectively laminated to the blade of the rotor and respectively to the cylinder (fixed member shaft) of the rotor. An evaluation is made to determine the coordinate and dynamics of the velocity of the magnetic fields. The magnetic or/electro-magnetic poles are adjacent to each other's magnetic field for a approximated responds of attraction and thus effort. In this manner, the magnet develop a force field for driving the rotor independently.

Thereby the magnetic field that is provided, forcefully attracting repelling and contracting the blades of the rotor. Thus the magnetic field provided forcefully driving the rotor. A coil or wire winding 18 is connected to the magnetic poles for inducing electronic current and voltage herein.

In illustration FIGS. 1A and 1D connections are made to form a ultra-powerful integrated rotor or armature 17 and shaft 14 magnetic AC/DC power source device. Technically, a plurality of electro-magnetic poles are connected in the center of the armature's rotating blade 30 to build up the charge in the device. Unit 1; 28 represent the first unit of north (N) and south (S) electro-magnetic poles. Unit 2; 29 is the second unit. It include a north magnetic or/electro-magnetic pole and, a south magnetic or/electro-magnetic pole this enclose the arrangement of the armature or rotor. From the left terminal 10 of the shaft 14, a shunt 26 connection is made respectively to the right terminal of the winding 18 or coil in contact with a first plurality unit of (N) and south (S) electro-magnetic poles. From the left terminal of another coil or winding and a north (NS) second plurality of magnetic or/electro-magnetic poles, a connection is made respectively to the (NS) poles of another second plurality of electro-magnetic poles unit 2 and to the right terminal of the winding or coil of the right side of the shaft 14. The magnetic or/electro-magnetic poles are connected so that they are varied when the circuit close and there is rotation.

The north pole is connected to the positive terminal 10, and the negative terminal is connected to the south pole 33 (S). Then the south is connected to the positive reserved terminal 10, and the north is connected to the reserved negative terminal that thereby constitute the very powerful independent magnetic/electro-magnetic AC/DC integrated generating device. Arrangement provided simultaneous and consecutive (AC/DC) current and voltage. The constitution of the winding 18 circuits of the natural magnetic or/electromagnetic generating device or rotor or armature 17 and fixed member (shaft) 14 device or apparatus is provided. Further, a logic unit is respectively connected to the magnetic or/electromagnetic (AC/DC rotor armature and shaft device for logical communication herein.

In the illustration FIG. 1B, the rotor or armature is connected in series 27 and parallel (shunt) 26 with the winding circuits. Connection commence as fallow. On the rotor or armature's north magnetic or/electro-magnetic pole 33 terminal 10, a connection is made to the positive input 21 terminal of the generating winding circuits. From the negative output 22 terminal of the winding, a connection is made respectively in series to the input of a resistor element 32. Another resistor is connected in shunt (parallel) with the rotor or natural magnetic or/electro-magnetic armature 17 for current flow 20 induction that thereby increasing the strength of the magnetic pole pieces and the output voltage.

The shunt resistor is variable. For more power and performance, a parallel shunt generation winding is respectively connected to the input positive terminal and output negative terminal of the pure magnetic or/electro-magnetic rotor or armature. The device is now self-exited. A parallel loop is then made respectively back to the positive north pole 12 and the negative south pole 11 of the magnetic rotor or armature. The device is now electromagnetic and magnetic. Thereby the residual magnetism in the pole pieces is able to produce an initial voltage. The current of the shunt circuit increases the magnetic field strength and the output voltage hereof. Unlike the series circuit of the device, the shunt circuit is able to build up voltage to the maximum value. When the continuous voltage of the series circuit become saturated, the shunt circuit is able to compensate and be constant because of the variable resistor circuit that is connected in series with the winding. The variable resistor regulates the shunt field current. A clock 24 is connected to the conductor of the loop cycle, for pulsating electronic signals back to the poles. Thus an enhance shunt serial magnetic or/and electro-magnetic rotor armature device/apparatus is formed.

Prospectively, a generational arrangement of powerful electronic energy is then provided. The magnetic rotor may be positioned or configured as a first phase rotor that emit output voltage from a loop cycle of at least two step-up transformers and further output voltages to the input of a step-down transformer circuit, with a loop cycle circuit, then output to the input of a second magnetic or/electro-magnetic rotor and fixed member device then the power will be more constant. A series parallel capacitor circuit may be connected from the output of the transformer network, and second electro-magnetic or magnetic-rotor or mechanical means to induce more power into the mechanical means electromagnetic rotor or and magnetic rotor.

At least one low band-pass (SLF) or (ELF) filter circuit 15 and a transceiver unit 16 is provided for transmitting the communication of power signals remotely or wirelessly. From a conductor, a connection is made to an series inductor 27. From the positive output terminal of the inductor, a connection is made to the positive terminal of a resistor 32. The resistor is coupled in parallel 26 to the inductor. Connections are made respectively to the negative terminal 10 of the low-band pass filter circuit. The frequency of the filter circuit is design to band in the 60 Hz range. 60 Hz is the band of frequency that carry the power band signals through the remote spectrum. Thereby the wanted power signals are passed within the band range of the filter circuit, and unwanted signals are not passed through the low band-pass filter circuit. For communicating power signals throughout the power channel system include the entire embodiments herein

FIG. 4 demonstrate connections to a (SLF) or (ELF) filter channel as fallow. For a wireless remote power from electronic socket, 19 connection are made from the output of the socket for residential or commercial use. From the output 22 terminals 10 of the socket, connection is respectively made to the input of a low band-pass (ELF) filter circuit 15 that passes at least 60 Hz of power signals from the output terminals. From the output of the filter circuit, connections are made respectively to the input 21 terminals of a transceiver unit. From the output terminals of the transceiver, a remote receiver is then able to receive the remote power signals from the stationary electronic socket. The immobile equipment or component that is coupled with the socket is now able to be mobile.

Connections are made for remote power-channel communication, as illustrated in FIG. 1B connection commence as fallow. From the output terminals of the independent magnetic rotor or armature 17 and fixed member (shaft) device or apparatus, a connection is made respectively to the loop cycle of transformer network 31. From the output of the transformer network's terminals 10, a connection is made respectively to a power source device 35. From the output terminals of the power source device, a connection is made respective to the input terminals of the (ELF) Extra Low Frequency band-pass filer circuit 15, which frequency is valued at 60 Hz to pass power signals remotely. From the output 22 terminal of the filter circuit, a connection is made respectively to the input terminals of a transceiver unit 16. Thereby a remote power (SLF) or (ELF) channel device is provided.

Connections are illustrated in FIG. 1B. The integrated independent magnetic rotor (armature) and fixed member (shaft) apparatus are device may be connected to generating means for generating relative motion in the magnetic field and thereby inducing voltage in the wire and magnet of the magnetic rotor and fixed member apparatus or device. The formation commence as fallow. Independent magnetic rotor or armature and shaft device is provided. The magnetic rotor and fixed member (shaft cylinder) device or apparatus has at least four magnetic poles 33. And the magnetic rotor or armature is connected, at the base, to at least four coils 18 at the transformer networks output terminals because of the motion of the magnetic rotor or armature device/apparatus's blades in relation with the transformer network's output coils. The independent magnetic rotor or armature and fixed member apparatus thereby inducing current and voltage in the terminals 10 of the generator to keep the generator running. The provided magnetic rotor or armature and fixed member shaft apparatus is able to be independent, and is able to induce voltage because of the means it is connected to, like the winding around the rotor and the transformer circuit along with the magnet. The magnetic rotor or armature and fixed member (shaft) apparatus is able to rotate in perpetual motion.

### Operation

### Figs.

Illustrated in FIG. 5. The manner of using the integrated remote power-source/power-supply device 35, magnetic-rotor means or/and electro-magnetic-rotor or armature 17 and fixed member (shaft) 14 device or means, magnetic mechanical means (motor) 36 and remote socket 19 system is provided as fallow. One would start by manually or remotely closing the power circuit by switch or remote control. When the circuit is closed and the magnetic field is attractive, responsive or induced, it forces electro-magnetic or magnetic remote signals to drive the system hereof. Remote power is applied to the remote power source/power-supply circuit, magnetic-rotor or armature device or means or/and electromagnetic rotor or armature device or means, magnetic mechanical means (motor) and the remote socket. Thereby communicating power signals to the system. The magnetic mechanical means (motor) thereby inducing electro-magnetic signals to the attractive poles 33 of the motor or magnetic mechanical means and forcing a field of magnet to attractive adjacent responsive magnetic-poles. Thereby driving the motor or mechanical means. Couple or plug the socket to the remote transceiver unit with the low band filter circuit. The socket is subsequently able to conduct remote power signals to a component that is coupled to a remote receiver.

### Advantages

From the description above, a number of advantages of my remote integrated incorporated power system that include a remote magnetic rotor or armature and fixed member (shaft) apparatus, a remote electro-magnetic rotor or armature device/apparatus, a remote power source/power-supply device and remote electronic socket become evident.
(a) A user may incorporate the system thereby remotely communicating power signals to mechanical means (motor), the independent magnetic rotor or armature and fixed member device/apparatus, the power-source/power-supply device and the remote electronic socket.
(b) The system may be divided into constituents, and thereby the independent magnetic rotor or armature and fixed member (shaft) device/apparatus will be an independent device/apparatus that communicate and induce energy power signals and compensate, with capital, for the shortage of energy resource such as oil.
(c) The electro-magnetic mechanical means (motor) are able to be used in a factory for the compensation of capital and the elimination of dangerous emission, it is able to be driven at great speeds, speeds as fast as an electronic pulse and emit no dangerous emission.
(d) The wireless electronic socket is able to couple and communicate power signal that are remote and thereby causing residential and commercial stationary components to be portable.

### Conclusion, Ramification, And Scope

Accordingly, the reader will see that the magnetic rotor or armature and fixed member device/apparatus, power-source/power-supply device, electro-magnetic mechanical means and electronic socket can be used in terms of compensating for capital, and it can be used to travel at the speed of an electronic pulse and to transceiver power signals independently with remote methods, and each individual constituent circuit or device is able to remotely drive a magnetic field and thereby influencing power. At least one integrated channel branch adapted or incorporated with channels and bands for coordinate and communication. The apparatuses and devices of this system are very cheap to manufacture and very easy to make.
It proved a remote method of communicating power signals;
It illuminate electronic shocks;
It provide simplex and duplex methods of communicating power signals;
It provide an indigenous method of inducing electronic current, voltage and energy, electricity and power;
It may be employed as an independent magnetic rotor or armature and fixed member device or apparatus thereby inducing power and rotating in perpetual motion;
It can be manufacture into a micro-chip so that it can be enclosed or integrated in a device such as a cell-phone or a laptop computer to eliminate the use of batteries and thereby making the cell-phone or laptop computer much more lighter and harder to brake when it is drops and making it more life lasting.
It eliminate dangerous emission and provide advance and extraordinary power and speed to an automobile, motor or mechanical means that are used in industrial areas such as factories and manufactures;
It put back the depleting magnetic field of the earth.
It reduce or eliminate dangerous emission from mechanical means (motor);
It can drive a motor to the speed of an electronic pulse;
It is able to communicate power signals to a remote electronic socket, and from thereto.

Although the description above contain many specificities, these specific examples should not be construed as limit to the scope, but as more providing illustrations of some of the preferred embodiment etc. The circuits that are provided in this invention may be connected to more than one circuits. The magnetic rotors or armature and fixed. member (shaft) device or apparatus may be employed or integrated into any apparatus or device herein or it can be employed in a device like a computer, or it can also be employed in residents such as homes and commercial areas such as businesses. The circuits thereof may be in series connection or parallel connection etc. or more sophisticated circuits.

Thus the scope of this invention should be determine by the appending claims and there legal equivalent, rather than the given examples.

I claim:

1. A method of influencing energy, comprising:
a) providing electro-magnetic means comprising at least one piston and at least one electro-magnet having a sign-pole and at least one cylinder-head having a second electro-magnet sign-pole that is able to communicate with said at least one piston,
b) providing a motor, thereby the communication of the at least one piston's magnetic field and the at least one cylinder head pole's magnet field are attractive to each other and thereby provides the effort for forcing said piston and driving said motor,
c) repelling said at least one piston so that said at least one piston is forced to move forward and thereby driving said motor or,
d) attracting with effort then contracting said at least one piston so that said at least one piston is able to be forced in contracting motion thereby driving said motor, to eliminate dangerous emission and for more power and speed,

2. The method of claim 1 wherein the electro-magnetic sign-poles are electro-magnetic poles, positioned or arranged, to attract with effort and influence responding velocity and communicate said magnetic field.

3. The method of claim 1 wherein said communication is velocity and the conveyance of said magnetic field.

4. A method of influencing powerful energy
a) Providing electro-magnetic means comprising at least one piston having at least one electro-magnetic sign-pole thereof and said electro-magnetic means are including at least one second electro-magnetic sign-pole that is attractive and adjacent to the first at least one electro-magnetic sign-pole and is capable of communicating with said first electro-magnetic sign pole,
b) providing a motor and communicating with said motor by forcing the magnetic field of said at least one piston,
c) forcing power to said at least one piston so that velocity is induced by the electro-magnetic field thereby driving said motor,
d) positioning or coordinating and arranging said first electro-magnetic sign-pole so that specific predetermination are cable of evaluating and applying the dynamic values to said at least one second electro-magnetic sign-pole,

5. The method of claim 4 wherein said at least one electro-magnetic sign-pole is comprised with a digital distributor unit for distributing pulses, and said digital distributor unit is capable of, thereby, inducing pulsated current and voltage to said at least one electro-magnetic sign-pole.

6. The method of claim 5 wherein said pulse is able to induce an electromagnetic force into said at least one electro-magnetic sign-pole for providing the effort that thus forcing the magnetic field onto, the attractive and responding, at least one first electro-magnetic pole, thereby driving said at least one electro-magnetic sign-pole in motion.

7. the method of claim 6 wherein said magnetic field is channeled by focusing said magnetic field to the field of the adjacent magnetic pole thereby efficiently driving the pole.

8. The method of claim 6 wherein said at least one electro-magnetic sign-pole is comprised with at least one piston. Thereby said at least one piston is cable of driving the motor.

9. The method of claim 5 wherein said digital distributor unit is able to employs a variable resistor that is able to vary the resistance and thereby providing the effort of variable voltage current and speed for varying the voltage and power at the speed of the electronic pulse.
